(19) United States
(12) Patent Application Publication
(10) Pub. No.: US 2025/0377513 A1
(43) Pub. Date: Dec. 11, 2025

(54) LC ADAPTER

(71) Applicant: HYC CO., LTD, Guangdong (CN)

(72) Inventors: Lei ZHU, Guangdong (CN); Haibo YANG, Guangdong (CN)

(21) Appl. No.: 18/877,148

(22) PCT Filed: Dec. 8, 2022
(86) PCT No.: PCT/CN2022/137437

§ 371 Date: Dec. 19, 2024

(30) Foreign Application Priority Data
Jul. 7, 2022 (CN) 202210802318.6

(51) Int. Cl. G02B 6/44

(52) U.S. Cl. CPC G02B 6/4444

(57) ABSTRACT

Provided is an LC adapter, belonging to the technical field of electronic devices. The LC adapter includes a housing (100), a clamping sleeve (200), and a lightproof assembly. The housing (100) is provided with an insertion hole (110) configured for a connector to insert into. The clamping sleeve (200) is disposed within the housing (100) and corresponds to the insertion hole (110) for the connector to insert into. The lightproof assembly includes a connection member (300) and an abutment member (400) connected to the connection member (300). The connection member (300) is rotatably connected within the housing (100). The abutment member (400) slidably fits the inner wall of the housing (100). The top wall of the connection member (300) is configured to abut against the connector to drive the abutment member (400) to rotate. The abutment member (400) abuts against the clamping sleeve (200) so that the abutment member (400) can be bent relative to the connection member (300) to expose or block the clamping sleeve (200).

This application claims priority to Chinese Patent Application No. 202210802318.6 filed with the China National Intellectual Property Administration (CNIPA) on Jul. 7, 2022, the disclosure of which is incorporated herein by reference in its entirety.

### TECHNICAL FIELD

The present application relates to the technical field of electronic devices, for example, an LC adapter.

### BACKGROUND

As interface converters, adapters are widely applied in the field of optical transmission. During the application of the adapters, dust affects the optical transmission, and invisible light in the optical transmission process may cause harm to an operator, so dustproof and lightproof properties of the adapters are very important.

In the related art, the adapters each include a housing, a clamping sleeve disposed within the housing and for a connector to insert into, and a lightproof plate hinged within the housing. The lightproof plate may be pushed open by inserting the connector into the housing, and the connection may be completed by inserting the connector into the clamping sleeve.

However, there are certain requirements for the overall thickness of the housing, that is, a certain thickness must be satisfied, and the overall dimension of the housing is not too large, which otherwise results in very limited space within the housing. When being installed, the lightproof plate can not only seal and shade a jack of the housing, but also be flipped to open the jack configured for the connector to insert into. Therefore, a sufficient space must be reserved between the clamping sleeve and the lightproof plate to ensure that the lightproof plate can be flipped smoothly. To ensure the flipping of the lightproof plate, the outer side surface of the housing is required to have an outward protrusion so that the internal space of the housing can be enlarged, increasing the height of the position on one side of the housing where the lightproof plate is assembled. As a result, multiple adapters can only be installed abreast in the left and right directions, limiting the application scenarios of the adapters.

### SUMMARY

The present application provides an LC adapter, which solves the problem in the related art that adapters can only be installed abreast because the outer dimensions of adapters are changed to ensure the smooth flipping of lightproof plates, limiting the application scenarios of the adapters.

The present application adopts the technical solutions below.

The present application provides an LC adapter. The LC adapter includes a housing, a clamping sleeve, and a lightproof assembly. The housing is provided with an insertion hole configured for a connector to insert into; the clamping sleeve is disposed within the housing and corresponds to the insertion hole configured for the connector to insert into. The lightproof assembly includes a connection member and an abutment member connected to the connection member, where the connection member is rotatably connected within the housing, the abutment member is configured to slidably fit against an inner wall of the housing, a top wall of the connection member is configured to abut against the connector to drive the abutment member to rotate, and the abutment member is configured to abut against the clamping sleeve so that the abutment member is bendable relative to the connection member to expose or cover the clamping sleeve.

### BRIEF DESCRIPTION OF DRAWINGS

FIG. 1 is an axonometric view of an LC adapter according to some embodiments of the present application.

FIG. 2 is a sectional view of an LC adapter according to some embodiments of the present application.

FIG. 3 is an axonometric view when clamping plates of an LC adapter are located on an upper side and a lower side according to some embodiments of the present application.

FIG. 4 is a view illustrating the structure of a connection member of an LC adapter according to some embodiments of the present application.

### REFERENCE LIST

100 housing
110 insertion hole
120 insertion sleeve
121 notch
130 cover plate
140 elastic sheet
141 clamping plate
150 clamping strip
200 clamping sleeve
300 connection member
310 connection plate
311 connection rod
320 press block
321 extrusion arc surface
400 abutment member
410 bending portion
411 elastic plate
412 bending line
420 abutment portion
421 abutment arc surface

### DETAILED DESCRIPTION

The present application is described in detail below in conjunction with drawings and embodiments.

In the description of the present application, terms “connected to each other”, “connected”, and “secured” are to be understood in a broad sense unless otherwise expressly specified and limited. For example, the term “connected” may refer to “securely connected”, “detachably connected”, or “integrated”, may refer to “mechanically connected” or “electrically connected”, or may refer to “connected directly”, “connected indirectly through an intermediary”, or “connected inside two components” or an interaction relation between two components. For those of ordinary skill in the art, specific meanings of the preceding terms in the present application may be understood based on specific situations.

In the present application, unless otherwise expressly specified and limited, when a first feature is described as being “on” or “under” a second feature, the first feature and the second feature may be in direct contact or may be in indirect contact via another feature between the two features instead of being in direct contact. Moreover, when the first feature is described as being “on”, “above”, or “over” the second feature, the first feature is right on, above, or over the second feature, the first feature is obliquely on, above, or over the second feature, or the first feature is simply at a higher level than the second feature. When the first feature is described as being “under”, “below”, or “underneath” the second feature, the first feature is right under, below, or underneath the second feature, the first feature is obliquely under, below, or underneath the second feature, or the first feature is simply at a lower level than the second feature.

In the description of embodiments, orientations or position relations indicated by terms such as “upper”, “lower”, and “right” are based on the drawings. These orientations or position relations are intended only to facilitate description and simplify operation and not to indicate or imply that a device or element referred to must have such particular orientations or must be configured or operated in such particular orientations. Thus, these orientations or position relations are not to be construed as limiting the present application. In addition, terms “first” and “second” are used only for distinguishing description and have no special meanings.

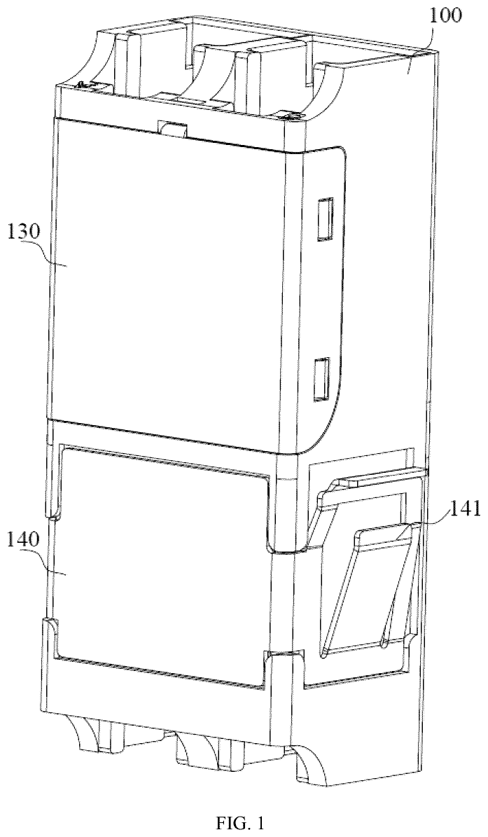

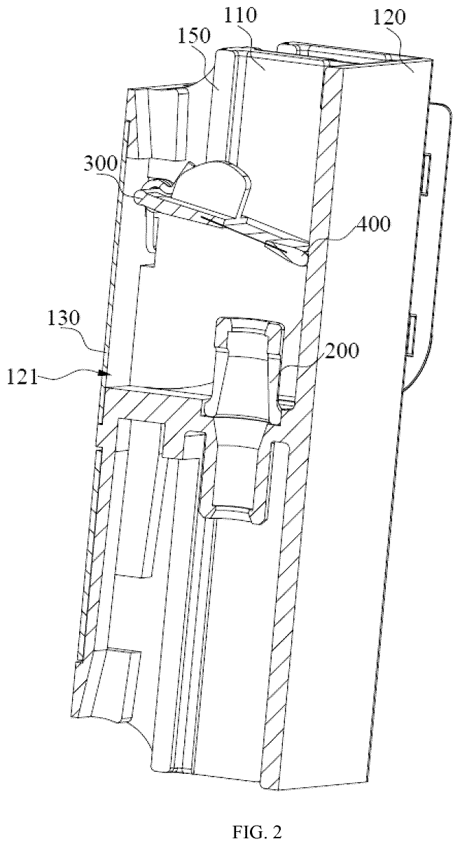

FIG. 1 is an axonometric view of an LC adapter according to some embodiments of the present application. FIG. 2 is a sectional view of an LC adapter according to some embodiments of the present application. Referring to FIGS. 1 and 2, the present application provides an LC adapter. The LC adapter includes a housing 100, a clamping sleeve 200, and a lightproof assembly. The housing 100 is provided with an insertion hole 110 configured for a connector to insert into. The clamping sleeve 200 is disposed within the housing 100 and corresponds to the insertion hole 110 for an insertion core of the connector to insert into. The lightproof assembly includes a connection member 300 and an abutment member 400 connected to the connection member 300. The connection member 300 is rotatably connected within the housing 100, the abutment member 400 slidably fits the inner wall of the housing 100, the top wall of the connection member 300 is configured to abut against the connector to drive the abutment member 400 to rotate, and the abutment member 400 abuts against the clamping sleeve 200 so that the abutment member 400 can be bent relative to the connection member 300 to expose or cover the clamping sleeve 200.

Exemplarily, the housing 100 as a whole may be in the shape of a cuboid, with front and rear ends being opened; the opening at the front end is used as the insertion hole 110, and the dimensions of front and rear ends on the outer side of the housing 100 remain consistent, that is, the dimension of the front end is the same as the dimension of the rear end. The clamping sleeve 200 may be secured within the housing 100 in a manner of engagement, welding, or bonding. One end of the clamping sleeve 200 facing the insertion hole 110 has a jack for the insertion core of the connector to insert into. It is to be understood that the outer shape of the housing 100 may also be other shapes such as a hexagon, as long as the requirement that multiple housings 100 are tightly attached to each other up and down or left and right and are distributed abreast can be satisfied, which is not limited in the present application.

The lightproof assembly is disposed within the housing 100 and on a side facing the insertion hole 110. The connection member 300 may be rotatably connected within the housing 100 through an elastic structure such as a torsion spring or a spring. A side surface of the connection member 300 may slidably fit against the inner sidewall of the housing 100. The abutment member 400 is disposed on the side surface of the connection member 300, and a side surface of the abutment member 400 also slidably fits the inner wall of the housing 100. Moreover, one side of the abutment member 400 facing away from the connection member 300 selectively abuts against the interior of the housing 100, thereby sealing the insertion hole 110.

In the application of the adapter, with the arrangement of the lightproof assembly, before the connector is inserted into the insertion hole 110, the abutment member 400 abuts against the interior of the housing 100 to cover the clamping sleeve 200 and keep the interior of the housing 100 sealed, thereby playing a role in dust prevention. When being inserted, the connector extrudes the connection member 300 so that the connection member 300 can drive the abutment member 400 to flip toward one side facing the clamping sleeve 200. After abutting against the clamping sleeve 200, the abutment member 400 is bent relative to the connection member 300 so that the abutment member 400 and the clamping sleeve 200 can be staggered to open the insertion hole 110, thereby allowing the connector to be smoothly inserted into the clamping sleeve 200. In this manner, the lightproof assembly opens or seals the insertion hole 110 by the bending of the abutment member 400 relative to the connection member 300, without adjusting the dimension of the housing 100, which is conducive to the consistency of the heights at two ends of the housing 100, so that the multiple housings 100 can be arranged closely and abreast up and down or left and right to improve the assembly density of adapters and expand the application scenarios. Moreover, during installation, the installation of the entire lightproof assembly may be completed by installing and securing the connection member 300, which effectively reduces the assembly difficulty and facilitates rapid completion of production.

Referring to FIG. 2, in some embodiments of the present application, the housing 100 includes an insertion sleeve 120 and a cover plate 130. An end surface of the insertion sleeve 120 is provided with the insertion hole 110, and multiple insertion holes 110 are provided. A side surface of the insertion sleeve 120 is provided with a notch 121 corresponding to the clamping sleeve 200. The cover plate 130 engages with the insertion sleeve 120 and seals the notch 121.

Exemplarily, the insertion sleeve 120 is in the shape of a long strip, and a longitudinal partition is disposed within the insertion sleeve 120; the longitudinal partition divides the interior of the insertion sleeve 120 into two spaces to form two insertion holes 110 and two cavities corresponding to the two insertion holes 110; one clamping sleeve 200 and one lightproof assembly are disposed within each of the two cavities. It is to be understood that multiple longitudinal partitions may also be provided to divide the interior of the insertion sleeve 120 into multiple cavities, and the number of longitudinal partitions may be designed according to the dimension of the insertion sleeve 120, which is not limited in the present application. The notch 121 is located on the side surface of the insertion sleeve 120 and adjacent to one side of a front end of the insertion sleeve 120 (that is, an end surface on which the insertion hole 110 is located). The notch 121 corresponds to the clamping sleeve 200. The cover plate 130 may be U-shaped to seal the notch 121. The cross-sectional area of the cover plate 130 is larger than the cross-sectional areas of two notches 121. Two sides of the cover plate 130 may engage with two sides of the insertion sleeve 120 by engagement buckles and engagement holes. It is to be understood that the cover plate 130 may also be securely connected to the insertion sleeve 120 by fasteners such as bolts, and the securing manner of the cover plate 130 may be designed according to the actual application requirements, which is not limited in the present application.

When the adapter is assembled, the cover plate 130 may be opened to expose the notch 121, and the lightproof assembly is installed using the notch 121. After the installation is completed, the cover plate 130 quickly engages with the insertion sleeve 120 to seal the notch 121 to reduce the difficulty of installing the lightproof assembly. When the connector and the clamping sleeve 200 are in insertion fit, the cover plate 130 may also be opened to maintain the connection between the connector and the clamping sleeve 200 through the notch 121.

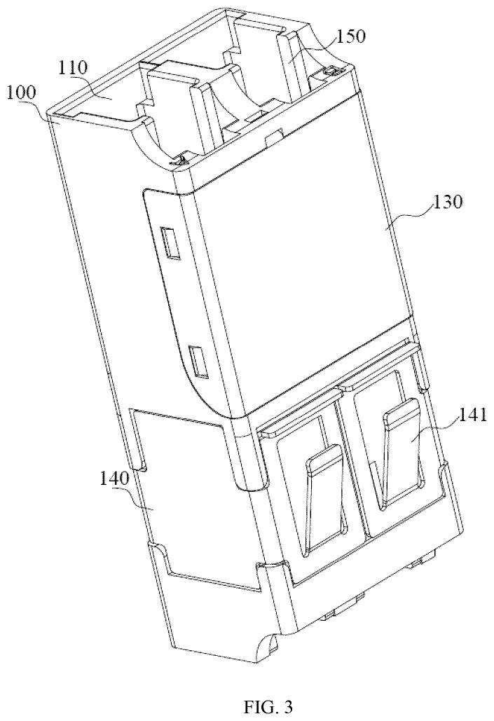

FIG. 3 is an axonometric view when clamping plates of an LC adapter are located on an upper side and a lower side according to some embodiments of the present application. Referring to FIGS. 1 and 3, in some embodiments of the present application, the LC adapter further includes an elastic sheet 140 and a clamping plate 141. The elastic sheet 140 is disposed on the outer sidewall of the housing 100. The clamping plate 141 is disposed on the elastic sheet 140. Exemplarily, the elastic sheet 140 surrounds and covers one side of the insertion sleeve 120 facing away from the front end, and the outer sidewall of the insertion sleeve 120 may be correspondingly formed with an installation groove into which the elastic sheet 140 is inlaid. The clamping plate 141 may be inclined on the elastic sheet 140, and the clamping plate 141 and the elastic sheet 140 may be integrally molded to improve the overall connection strength. The distance from the clamping plate 141 to the outer sidewall of the insertion sleeve 120 increases by degrees from a rear end of the insertion sleeve 120 (that is, an end surface opposite to the end surface on which the insertion hole 110 is located) to the front end of the insertion sleeve 120. Two clamping plates 141 may be provided, and each clamping sleeve 200 corresponds to a respective clamping plate 141. The two clamping plates 141 may be located on an upper side of the elastic sheet 140 and a lower side of the elastic sheet 140, or on a left side of the elastic sheet 140 and a right side of the elastic sheet 140. When the two clamping plates 141 are disposed on the left side of the elastic sheet 140 and the right side of the elastic sheet 140, one side of each elastic sheet 140 facing the insertion hole 110 may also be locally raised, and the locally raised portion of the elastic sheet 140 abuts against an installation plate to facilitate abreast distribution. It is to be understood that the positions and number of clamping plates 141 may be designed according to the actual application scenarios, which are not limited in the present application.

When multiple adapters are arranged, due to the same outer dimension of the multiple adapters and no noticeable protruding structure, the multiple adapters may be stacked up and down or arranged abreast according to the application scenarios and securely connected by the mutual engagement of the two clamping plates 141 and the installation plate to secure the multiple adapters to the installation plate. In this manner, the multiple adapters can form different arrangements and combinations on various different occasions so that the multiple adapters can be adapted to the different application occasions to improve the application range of the multiple adapters. Exemplarily, when the multiple adapters are stacked up and down, the two clamping plates 141 may be located on the left side of the elastic sheet 140 and the right side of the elastic sheet 140, and when the multiple adapters are arranged abreast, the two clamping plates 141 may be located on the upper side of the elastic sheet 140 and the lower side of the elastic sheet 140.

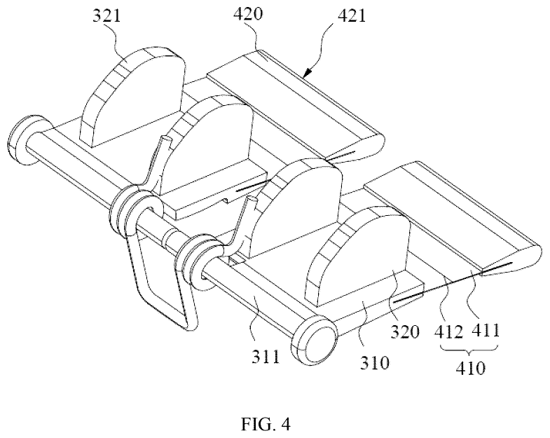

FIG. 4 is a view illustrating the structure of a connection member of an LC adapter according to some embodiments of the present application. Referring to FIG. 4, in some embodiments of the present application, the connection member 300 includes a connection plate 310 and a press block 320. The connection plate 310 is rotatably connected to the inner wall of the housing 100. The press block 320 is secured to the top wall of the connection plate 310 and configured to abut against the connector.

Exemplarily, the connection plate 310 is rotatably connected to the inner wall of the housing 100 through a torsion spring; one torsion spring may be provided, and two ends of the torsion spring extend into the two cavities through the two notches 121; two connection plates 310 are each provided with one connection rod 311, and the two ends of the torsion spring are sleeved on the two connection rods 311; the two connection rods 311 are rotatably connected to the inner wall of the housing 100. It is to be understood that two torsion springs may also be provided, that is, each connection plate 310 corresponds to a respective torsion spring. The torsion spring may also be replaced by a spring. For example, the inner wall of the housing 100 is formed with an arc groove, one slider that can slide within the arc groove is secured to the connection plate 310, and a spring is disposed within the arc groove to limit the sliding of the slider, thereby limiting the rotation of the connection plate 310. The connection structure of the connection plate 310 may be designed according to the actual installation requirements, as long as the connection plate 310 is simple in structure and reliable in operation, and this is not limited in the present application.

The press block 320 is sheet-shaped and stands on the top wall of the connection plate 310, and the top wall of each connection plate 310 may be provided with two press blocks 320, and the two press blocks 320 are disposed opposite to each other and are located on two sides of each connection plate 310 respectively. Optionally, the top wall of the press block 320 has an extrusion arc surface 321 configured to abut against the connector. The top wall of the press block 320 may be provided with the extrusion arc surface 321 to match the outer shape of the housing of the connector. It is to be understood that the extrusion arc surface 321 may be complete or may also be formed by connecting several arc surfaces sequentially to facilitate the matching of the outer shape of the connector.

Referring to FIG. 2, a clamping strip 150 may also be secured to the hole wall of the insertion hole 110, and the bottom wall of the clamping strip 150 selectively abuts against the top wall of the connection plate 310 to limit the movement range of the connection plate 310. Two clamping strips 150 are provided, and the two press blocks 320 are located between the two clamping strips 150. It is to be understood that only one clamping strip 150 may also be provided; the shape of the clamping strip 150 may be a long strip, a rectangular protrusion, or a semicircular protrusion, which is not limited in the present application.

When being inserted, the connector first tightly abuts against the extrusion arc surface 321 to push the connection plate 310 to rotate by the press block 320, and the connection plate 310 drives the connecting rod 311 to rotate and simultaneously pulls the torsion spring to be elastically deformed. As the connection plate 310 rotates, the abutment member 400 is driven to rotate so that the abutment member 400 can tightly abut against the clamping sleeve 200. Moreover, as the connection plate 310 continues being flipped, the clamping sleeve 200 can extrude the abutment member 400 so that the abutment member 400 can be flipped relative to the connection plate 310. Moreover, after the connector is inserted, the housing of the connector first abuts against the press block 320. As the connector continues being inserted, the abutment member 400 is flipped downward accordingly so that the insertion core of the connector cannot contact the abutment member 400, thereby reducing the possibility of damage to the insertion core.

Referring to FIG. 4, in some embodiments of the present application, the abutment member 400 includes a bending portion 410 and an abutment portion 420. The bending portion 410 is securely connected to the connection member 300 and may be bent relative to the connection member 300 so that one side of the bending portion 410 facing away from the connection member 300 can be bent. The abutment portion 420 is secured to the side of the bending portion 410 facing away from the connection member 300 so as to rotate with the bending of the bending portion 410.

Exemplarily, the bending portion 410 may be formed by a structure with a certain elasticity and can be bent along a middle portion so that two sides of the bending portion 410 can be relatively bent; one side of the bending portion 410 is securely connected to the connection plate 310, and the other side of the bending portion 410 is securely connected to the abutment portion 420 so that the abutment portion 420 can rotate relative to the connection plate 310. One side of the abutment portion 420 facing away from the connection plate 310 may be provided with an abutment arc surface 421, and the abutment arc surface 421 abuts against the inner sidewall of the housing 100 so that the abutment portion 420 can slide relative to the inner wall of the housing 100. The thickness of the abutment portion 420 increases by degrees from one side facing the bending portion 410 to the other side facing away from the bending portion 410 to increase the contact area between the abutment portion 420 and the inner wall of the housing 100, thereby improving the sealing performance. The bending portion 410 includes an elastic plate 411. Optionally, one side of the abutment portion 420 facing away from the elastic plate 411 has the abutment arc surface 421 abutting against the interior of the housing; and/or the thickness of one side of the abutment portion 420 facing away from the bending portion 410 is larger than the thickness of the other side of the abutment portion 420 facing the bending portion 410.

When the connection plate 310 rotates to drive the bending portion 410 and the abutment portion 420 to rotate synchronously, the bottom wall of the abutment portion 420 abuts against the clamping sleeve 200, and the clamping sleeve 200 drives the bending portion 410 to bend in this case so that the abutment portion 420 can be flipped relative to the connection plate 310. As the connection plate 310 continues being flipped, the abutment portion 420 is misaligned with the clamping sleeve 200, thereby smoothly exposing the clamping sleeve 200. When the connector is pulled out, the torsion spring drives the connection plate 310 to reset, and in this case, the top wall of the abutment portion 420 abuts against the clamping sleeve 200, driving the bending portion 410 to bend toward the other side. As the connection plate 310 is reset, the abutment portion 420 is misaligned with the clamping sleeve 200 again so that the abutment portion 420 can abut against the interior of the housing 100, thereby completing the reset.

Referring to FIG. 4, in some embodiments of the present application, the bending portion 410 includes the elastic plate 411, and a middle portion of the elastic plate 411 is provided with a bending line 412 so that the elastic plate 411 can be bent along the bending line 412. Exemplarily, a side surface of the connection plate 310 and a side surface of the abutment portion 420 are each formed with an inlay groove, and two sides of the elastic plate 411 are inlaid within the two inlay grooves respectively. The elastic plate 411 is an elastic metal sheet, a line is formed in a middle portion of the elastic metal sheet as the bending line 412, and the bending line 412 is between the connection plate 310 and the abutment portion 420 so that the two sides of the elastic plate 411 can be bent around the bending line 412. The connection plate 310 may also be an elastic hinge such as a spring hinge. Plate-shaped structures on two sides of the elastic hinge form the bending portion 410, and the axis of a conversion shaft in the middle of the elastic hinge may be used as the bending line. It is to be understood that the structure of the elastic plate 411 may be designed according to the actual application scenarios, as long as the force driving the connection plate 310 to reset is larger than the elastic force of the elastic plate 411, that is, the elastic force of the torsion spring or the spring is larger than the elastic force of the elastic plate 411. After being extruded by the clamping sleeve 200, the abutment portion 420 drives the elastic plate 411 to bend along the bending line 412 so that the abutment portion 420 can be staggered with the clamping sleeve 200, and the abutment portion 420 can smoothly open or seal the insertion hole 110.

1. An LC adapter, comprising:
a housing provided with an insertion hole configured for a connector to insert into;
a clamping sleeve disposed within the housing and corresponding to the insertion hole configured for the connector to insert into; and
a lightproof assembly comprising a connection member and an abutment member connected to the connection member, wherein the connection member is rotatably connected within the housing, the abutment member is configured to slidably fit against an inner wall of the housing, a top wall of the connection member is configured to abut against the connector to drive the abutment member to rotate, and the abutment member is configured to abut against the clamping sleeve so that the abutment member is bendable relative to the connection member to expose or cover the clamping sleeve.

2. The LC adapter of claim 1, wherein the abutment member comprises:
a bending portion securely connected to the connection member, wherein the bending portion is configured to bend relative to the connection member so that one side of the bending portion facing away from the connection member is bent; and
an abutment portion secured to the side of the bending portion facing away from the connection member so as to rotate with bending of the bending portion.

3. The LC adapter of claim 2, wherein the bending portion comprises:
an elastic plate, wherein a middle portion of the elastic plate is provided with a bending line so that the elastic plate is bendable along the bending line.

4. The LC adapter of claim 3, wherein the elastic plate is an elastic metal sheet or an elastic hinge.

5. The LC adapter of claim 3, wherein
one side of the abutment portion facing away from the elastic plate is provided with an abutment arc surface abutting against an interior of the housing; and
a thickness of one side of the abutment portion facing away from the bending portion is larger than a thickness of another side of the abutment portion facing the bending portion.

6. The LC adapter of claim 1, wherein the connection member comprises:
a connection plate rotatably connected to the inner wall of the housing; and
a press block secured to a top wall of the connection plate and configured to abut against the connector.

7. The LC adapter of claim 6, wherein a top wall of the press block is provided with an extrusion arc surface configured to abut against the connector.

8. The LC adapter of claim 1, wherein the connection member is rotatably connected to the housing through a torsion spring.

9. The LC adapter of claim 1, further comprising:
an elastic sheet disposed on an outer sidewall of the housing; and
a clamping plate disposed on the elastic sheet.

10. The LC adapter of claim 1, wherein the housing is provided with a plurality of insertion holes;
the housing comprises:
an insertion sleeve, wherein an end surface of the insertion sleeve is provided with the plurality of insertion holes; a side surface of the insertion sleeve is provided with a notch corresponding to the clamping sleeve; and
a cover plate engaging with the insertion sleeve and sealing the notch.

11. The LC adapter of claim 3, wherein one side of the abutment portion facing away from the elastic plate is provided with an abutment arc surface abutting against an interior of the housing.

12. The LC adapter of claim 3, wherein a thickness of one side of the abutment portion facing away from the bending portion is larger than a thickness of another side of the abutment portion facing the bending portion.

13. The LC adapter of claim 2, wherein the connection member comprises:
a connection plate rotatably connected to the inner wall of the housing; and
a press block secured to a top wall of the connection plate and configured to abut against the connector.

14. The LC adapter of claim 3, wherein the connection member comprises:
a connection plate rotatably connected to the inner wall of the housing; and
a press block secured to a top wall of the connection plate and configured to abut against the connector.

15. The LC adapter of claim 4, wherein the connection member comprises:
a connection plate rotatably connected to the inner wall of the housing; and
a press block secured to a top wall of the connection plate and configured to abut against the connector.

16. The LC adapter of claim 5, wherein the connection member comprises:
a connection plate rotatably connected to the inner wall of the housing; and
a press block secured to a top wall of the connection plate and configured to abut against the connector.

17. The LC adapter of claim 2, wherein the connection member is rotatably connected to the housing through a torsion spring.

18. The LC adapter of claim 3, wherein the connection member is rotatably connected to the housing through a torsion spring.

19. The LC adapter of claim 4, wherein the connection member is rotatably connected to the housing through a torsion spring.

20. The LC adapter of claim 5, wherein the connection member is rotatably connected to the housing through a torsion spring.
